(19) United States
(12) Patent Application Publication
(10) Pub. No.: US 2007/0050639 A1
(43) Pub. Date: Mar. 1, 2007

(54) Authentication apparatus and authentication method

(75) Inventors: Yuusuke Nakano, Nagoya-shi (JP); Yuichi Kawakami, Nishinomiya-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/507,830

(22) Filed: Aug. 22, 2006

(30) Foreign Application Priority Data
Aug. 23, 2005 (JP) JP2005-240907

(51) Int. Cl. H04L 9/00; H04K 1/00

(52) U.S. Cl. 713/186; 713/179

(57) ABSTRACT

The present invention provides an authentication apparatus comprising a first acquiring part for acquiring three-dimensional information of a first object to be authenticated, a second acquiring part for acquiring two-dimensional information of the first object and an authenticating part for performing an authenticating operation on the first object by using the three-dimensional information and the two-dimensional information.

This application is based on application No. 2005-240907 filed in Japan, the contents of which are hereby incorporated by reference.

### BACKGROUND OF THE INVENTION

1. Field of the Invention

The present invention relates to a technique for authenticating an object.

2. Description of the Background Art

In recent years, various electronized services are being spread with development in the network techniques and the like, and the non-face-to-face personal authentication techniques are in increasing demand. To address the demand, the biometric authentication techniques for automatically identifying a person on the basis of biometric features of the person are being actively studied. The face authentication technique as one of the biometric authentication techniques is a non-face-to-face authentication method and is expected to be applied to various fields of security with a monitor camera, an image database using faces as keys, and the like.

At present, as an authentication method using two-dimensional information obtained from a face image as a face authentication technique, a method realizing improvement in authentication accuracy by using a three-dimensional shape of a face as supplementary information for authentication is proposed (refer to Japanese Patent Application Laid-Open No. 2004-126738).

The method, however, has a problem such that since the three-dimensional shape information (hereinafter, also referred to as three-dimensional information) of the face is used just as supplementary information for authentication and the authentication is performed basically with the two-dimensional information, the authentication accuracy is not sufficiently high.

The problem is not peculiar to the face authentication. Authentication of another object also has a similar problem.

### SUMMARY OF THE INVENTION

The present invention aims at providing a technique capable of performing authentication at higher accuracy as compared with the case of performing authentication using only two-dimensional information obtained from an object to be authenticated.

In order to accomplish this aim, an authentication apparatus of the present invention includes: a first acquiring part for acquiring three-dimensional information of a first object to be authenticated; a second acquiring part for acquiring two-dimensional information of the first object; and an authenticating part for performing an authenticating operation on the first object by using the three-dimensional information and the two-dimensional information.

Since the authentication apparatus performs an authenticating operation using three-dimensional information and two-dimensional information of an object to be authenticated, high-accuracy authentication can be realized.

The present invention is also directed to an authentication method.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a configuration diagram showing an example of applying a face authentication system according to a preferred embodiment of the present invention;

FIG. 2 is a diagram showing a schematic configuration of a controller;

FIG. 3 is a block diagram showing various functions of the controller;

FIG. 4 is a block diagram showing a detailed functional configuration of a personal authenticating part;

FIG. 5 is a block diagram showing a further detailed functional configuration of an image normalizing part;

FIG. 6 is a flowchart showing general operation of a controller;

FIG. 7 is a detailed flowchart of an image normalizing process;

FIG. 8 is a diagram showing feature points of a characteristic part in a face image;

FIG. 9 is a schematic diagram for calculating three-dimensional coordinates from feature points in a two-dimensional image;

FIG. 10 is a diagram showing a standard model of a three-dimensional face;

FIG. 11 is a diagram showing texture information;

FIG. 12 is a diagram showing individual control points of a characteristic part after normalization;

FIG. 13 is a diagram showing the relation between distance between a person to be authenticated and a camera and a weight factor;

FIG. 14 is a diagram showing correspondence between a predetermined distance determined on the basis of the relation of FIG. 13 and the weight factor;

FIG. 15 is a diagram showing the relation between a plurality of determination elements (parameters) and the weight factor; and

FIG. 16 is a diagram showing a three-dimensional shape measuring device constructed by a laser beam emitter and a camera.

### DESCRIPTION OF THE PREFERRED EMBODIMENT

A preferred embodiments of the present invention will be described below with reference to the drawings. Although authentication of a face will be described in the following preferred embodiments, the present invention can be also applied to authentication of other objects.

### Preferred Embodiment

Outline

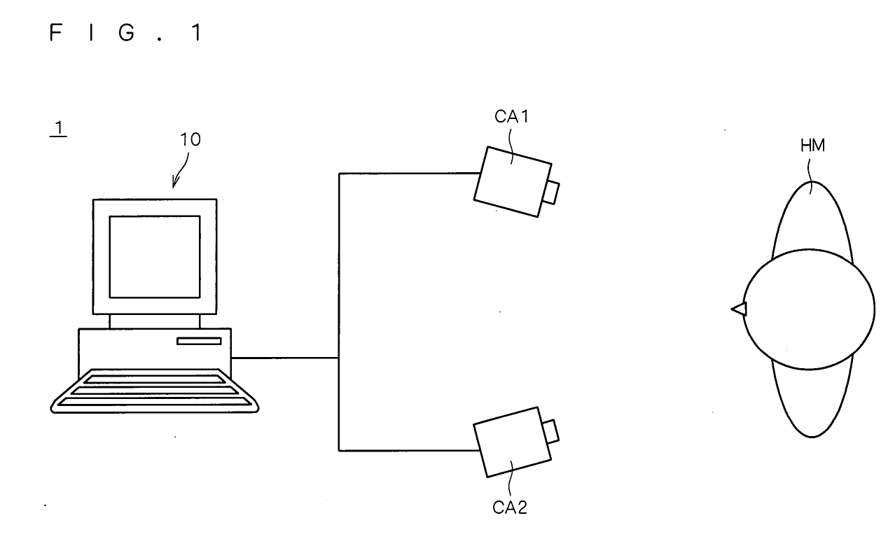

FIG. 1 is a configuration diagram showing a face authentication system 1 according to a preferred embodiment of the present invention. As shown in FIG. 1, the face authentication system 1 is constructed by a controller 10 and two image capturing cameras (hereinafter, also simply referred to as “cameras”) CA1 and CA2. The cameras CA1 and CA2 are disposed so as to be able to capture images of the face of a person HM to be authenticated from different positions. When face images of the person to be authenticated are captured by the cameras CA1 and CA2, appearance information, specifically, two kinds of face images of the person to be authenticated captured by the image capturing operation is transmitted to the controller 10 via a communication line. The communication method for image data between the cameras and the controller 10 is not limited to a wired method but may be a wireless method.

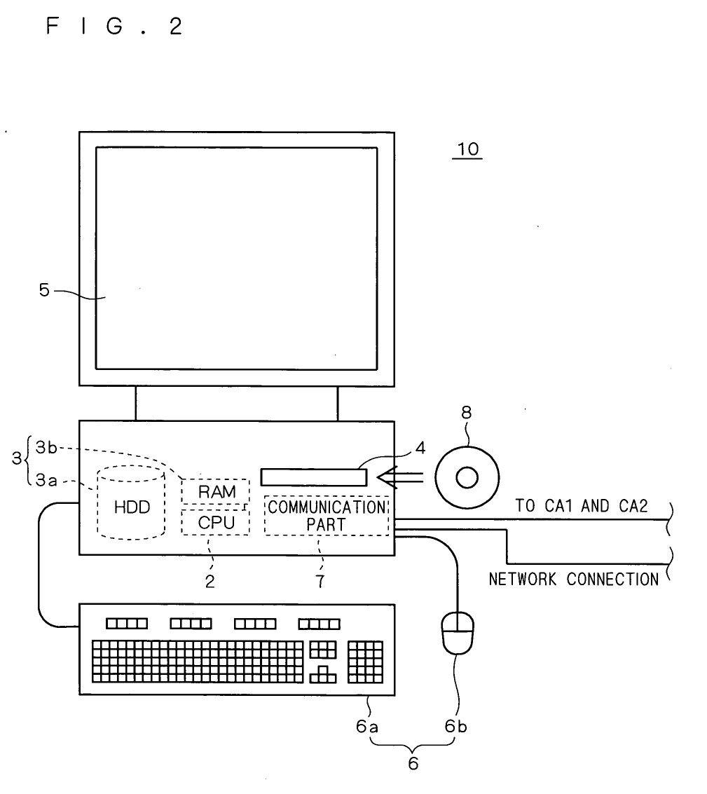

FIG. 2 is a diagram showing a schematic configuration of the controller 10. As shown in FIG. 2, the controller 10 is a general computer such as a personal computer including a CPU 2, a storage 3, a media drive 4, a display 5 such as a liquid crystal display, an input part 6 such as a keyboard 6a and a mouse 6b as a pointing device, and a communication part 7 such as a network card. The storage 3 has a plurality of storing media, concretely, a hard disk drive (HDD) 3a and a RAM (semiconductor memory) 3b capable of performing processes at a higher speed than the HDD 3a. The media drive 4 can read information recorded on a portable recording medium 8 such as CD-ROM, DVD (Digital Versatile Disk), flexible disk, or memory card. The information supplied to the controller 10 is not limited to information supplied via the recording medium 8 but may be information supplied via a network such as LAN or the Internet.

Next, various functions of the controller 10 will be described.

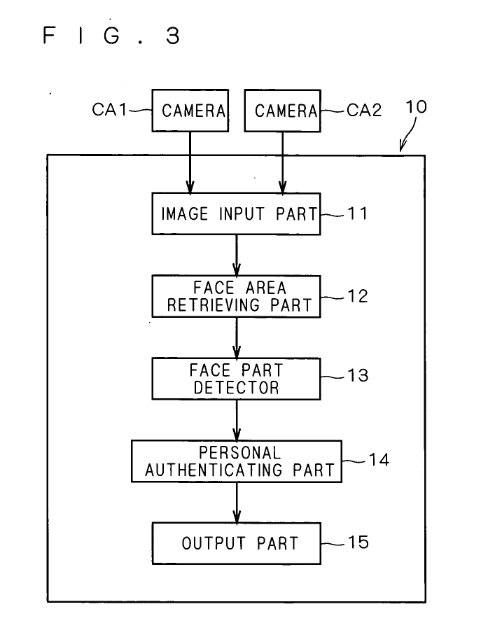

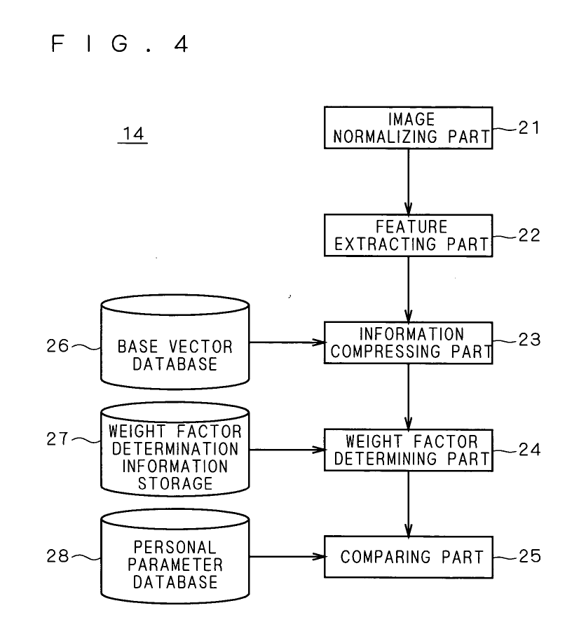

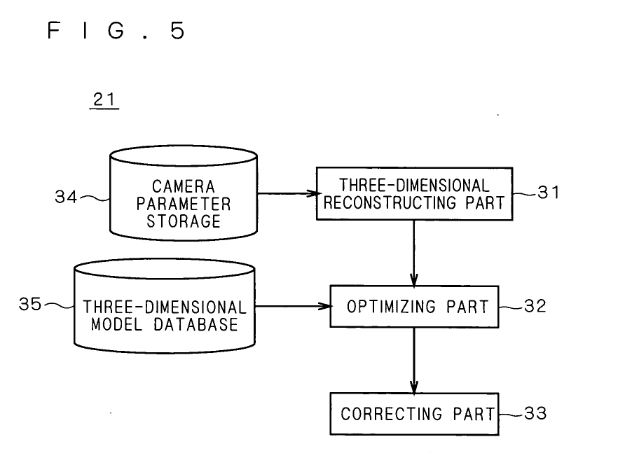

FIG. 3 is a block diagram showing the various functions of the controller 10. FIG. 4 is a block diagram showing a detailed functional configuration of a personal authenticating part 14. FIG. 5 is a block diagram showing a detailed functional configuration of an image normalizing part 21.

The various functions of the controller 10 are conceptual functions realized by executing a predetermined software program (hereinafter, also simply referred to as “program”) with various kinds of hardware such as the CPU in the controller 10.

As shown in FIG. 3, the controller 10 has an image input part 11, a face area retrieving part 12, a face part detector 13, the personal authenticating part 14, and an output part 15.

The image input part 11 has the function of inputting two images captured by the cameras CA1 and CA2 to the controller 10.

The face area retrieving part 12 has the function of specifying a face part in an input face image.

The face part detector 13 has the function of detecting the positions of characteristic parts (for example, eyes, eyebrows, nose, mouth, and the like) in the specified face area.

The personal authenticating part 14 is constructed to mainly authenticate a face and has the function of authenticating a person on the basis of a face image. The details of the personal authenticating part 14 will be described later.

The output part 15 has the function of outputting an authentication result obtained by the person authenticating part 14.

Next, the detailed configuration of the personal authenticating part 14 will be described with reference to FIGS. 4 and 5.

As shown in FIG. 4, the personal authenticating part 14 has the image normalizing part 21, a feature extracting part 22, an information compressing part 23, a weight coefficient determining part 24, and a comparing part 25.

The image normalizing part 21 has the function of normalizing information of a person to be authenticated (object to be authenticated). As shown in FIG. 5, the image normalizing part 21 has: a three-dimensional reconstructing part 31 for calculating coordinates of each part in three dimensions from coordinates of a characteristic part in a face obtained from an input image; an optimizing part 32 for generating an individual model by using the calculated three-dimensional coordinates; and a correcting part 33 for correcting the generated individual model. By the processing parts 31, 32, and 33, information of the person to be authenticated is normalized and converted to information which can be easily compared. The individual model generated by the function of the processing parts includes both three-dimensional information and two-dimensional information of the person to be authenticated. The “three-dimensional information” is information related to a stereoscopic configuration constructed by three-dimensional coordinate values or the like. The “two-dimensional information” is information related to a plane configuration constructed by surface information (texture information) and/or information of positions in a plane or the like.

The feature extracting part 22 has a feature extracting function of extracting the three-dimensional information and two-dimensional information from a three-dimensional face model obtained by the image normalizing part 21.

The information compressing part 23 has the function of compressing the three-dimensional information and the two-dimensional information used for face authentication by converting each of the three-dimensional information and the two-dimensional information extracted by the feature extracting part 22 to a proper face feature amount for face authentication. The information compressing function is realized by using information stored in a base vector database 26 and the like.

The weight factor determining part 24 has the function of determining reliability of the three-dimensional and two-dimensional face feature amounts (reliability of the three-dimensional information and reliability of the two-dimensional information) in accordance with shooting conditions and the like and deciding a weight factor used for similarity calculation. The weight factor is determined by using information stored in a weight factor determination information storage 27.

The comparing part 25 has the function of calculating similarity between a face characteristic amount of a registered person (person to be compared), which is pre-registered in a personal parameter database 28 and a face characteristic amount of the person to be authenticated, which is obtained by the above-described function parts and the like, thereby authenticating the face.

Operations

The functions of the controller 10 will be described in more details below.

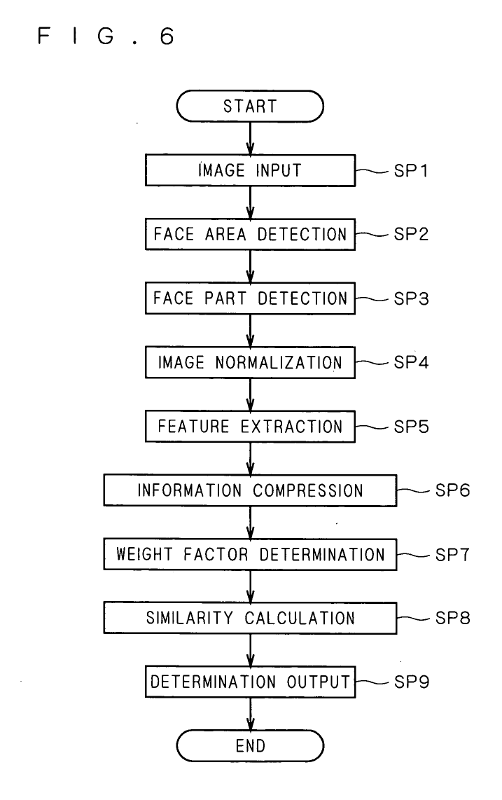

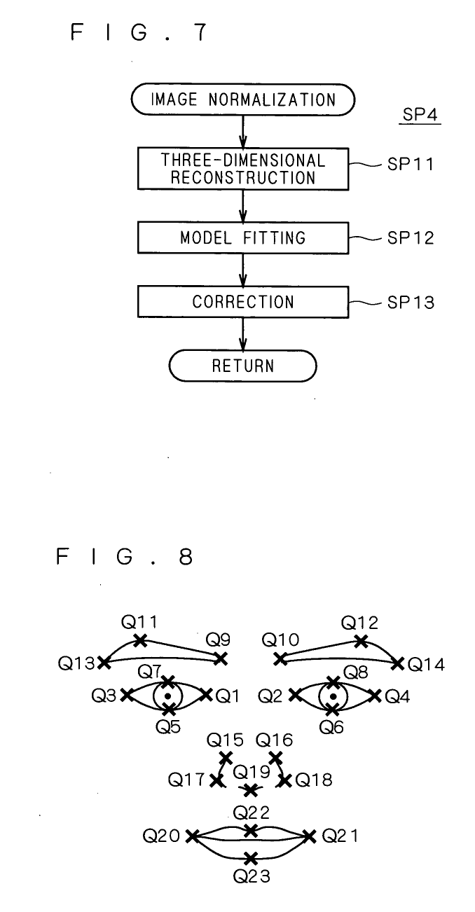

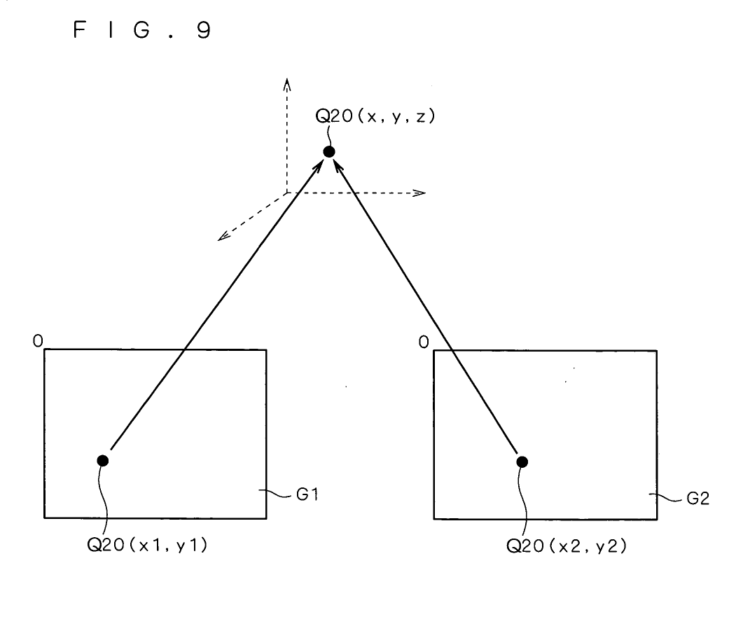

FIG. 6 is a flowchart showing general operations of the controller 10. FIG. 7 is a detailed flowchart of an image normalizing process (step SP4). FIG. 8 is a diagram showing feature points of a feature part in a face image. FIG. 9 is a schematic diagram showing a state where three-dimensional coordinates are calculated by using the principle of triangulation from feature points in two-dimensional images. Reference numeral G1 in FIG. 9 denotes an image G1 captured by the camera CA1 and input to the controller 10. Reference numeral G2 denotes an image G2 captured by the camera CA2 and input to the controller 10. Points Q20 in the images G1 and G2 correspond to the right end of a mouth in FIG. 8.

In the following, the case of performing the face authentication of a predetermined person whose face is photographed by the cameras CA1 and CA2 as a person to be authenticated will be described. In this case, three-dimensional shape information measured on the basis of the principle of triangulation by using images captured by the cameras CA1 and CA2 is used as the three-dimensional information, and texture (brightness) information is used as the two-dimensional information.

As shown in FIG. 6, the controller 10 acquires a face feature amount of the person to be authenticated on the basis of captured images of the face of the person to be authenticated in the processes from step SP1 to step SP6. Further, by performing the processes from step SP7 to step SP9, face authentication is realized.

First, in step SP1, images of the face of a predetermined person (person to be authenticated), captured by the cameras CA1 and CA2 are input to the controller 10 via a communication line. Each of the cameras CA1 and CA2 for capturing face images takes the form of a general image capturing apparatus capable of capturing a two-dimensional image. A camera parameter Bi (i=1 . . . N) indicative of the positional posture of each camera CAi or the like is known and is pre-stored in a camera parameter storage 34 (FIG. 5). N indicates the number of cameras. Although the case where N=2 is described in the preferred embodiment, N may be three or more (N≧3, three or more cameras may be used). The camera parameter Bi will be described later.

In step SP2, an area where the face exists is detected from each of the two images input from the cameras CA1 and CA2. As a face area detecting method, a method of detecting a face area from each of the two images by template matching using a prepared standard face image can be employed.

In step SP3, the position of a feature part in the face is detected from the face area image detected in step SP2. Examples of the feature parts in the face are eyes, eyebrows, nose, and mouth. In step SP3, the coordinates of feature points Q1 to Q23 of the parts as shown in FIG. 8 are calculated. A feature part can be detected by template matching using a standard template of the feature part. The coordinates of a feature point to be calculated are expressed as coordinates on the images G1 and G2 input from the cameras. For example, with respect to the feature point Q20 corresponding to the right end of the mouth in FIG. 8, as shown in FIG. 9, coordinate values in the two images G1 and G2 are calculated. Concretely, by using the upper left end point of the image G1 as the origin O, coordinates (x1, y1) on the image G1 of the feature point Q20 are calculated. In the image G2 as well, similarly, coordinates (x2, y2) on the image G2 of the feature point Q20 are calculated.

A brightness value of each of pixels in an area using, as an apex point, a feature point in an input image is acquired as information of the area (hereinafter, also referred to as “texture information”). The texture information in each area is assigned (mapped) to an individual model in step SP12 or the like which will be described later. In the case of the preferred embodiment, the number of input images is two, so that an average brightness value in corresponding pixels in corresponding areas in the images is used as the texture information of the area.

In step SP4 (image normalizing process), image information of the person to be authenticated is normalized on the basis of the coordinate values of feature points, texture information of the areas, and the like detected in step SP3. The image normalizing process (step SP4) has, as shown in FIG. 7, a three-dimensional reconstruction process (step SP11), a model fitting process (step SP12), and a correcting process (step SP13). By performing the processes, the information of the person to be authenticated is generated in a normalized state as an “individual model” including both the three-dimensional information and the two-dimensional information of the person to be authenticated. In the following, each of the processes (steps SP11 to SP13) will be described in detail.

First, in the three-dimensional reconstruction process (step SP11), three-dimensional coordinates M^{(j)} (j=1 . . . m) of each feature point Qj are calculated on the basis of two-dimensional coordinates Ui^{(j)} in each of images Gi (i=1, . . . , N) at the feature points Qj detected in step SP3 and the camera parameters Bi of the camera which has captured the images Gi. Herein, “m” denotes the number of feature points.

Calculation of the three-dimensional coordinates M^{(j)} will be described concretely below.

The relations among the three-dimensional coordinates M^{(j)} at each feature point Qj, the two-dimensional coordinates Ui^{(j)} at each feature point Qj, and the camera parameter Bi are expressed as Expression (1).
μiUi^{(j)}=BiM^{(j)} (1)

Herein, μi is a parameter indicative of a fluctuation amount of a scale. A camera parameter matrix Bi indicates values peculiar to each camera, which are obtained by capturing an object whose three-dimensional coordinates are previously known, and is expressed by a projection matrix of 3×4.

As a concrete example of calculating three-dimensional coordinates by using Expression (1), the case of calculating three-dimensional coordinates M⁽²⁰⁾ at a feature point Q20 will be considered with reference to FIG. 9. Expression (2) shows the relation between coordinates (x1, y1) at the feature point Q20 on the image G1 and three-dimensional coordinates (x, y, z) when the feature point Q20 is expressed in a three-dimensional space. Similarly, Expression (3) shows the relation between the coordinates (x2, y2) at the feature point Q20 on the image G2 and the three-dimensional coordinates (x, y, z) when the feature point Q20 is expressed in a three-dimensional space.

$$\begin{matrix}μ 1 ( \begin{matrix}x 1 \\ y 1 \\ 1\end{matrix} ) = B 1 ( \begin{matrix}x \\ y \\ z \\ 1\end{matrix} ) & ( 2 ) \\ μ 2 ( \begin{matrix}x 2 \\ y 2 \\ 1\end{matrix} ) = B 2 ( \begin{matrix}x \\ y \\ z \\ 1\end{matrix} ) & ( 3 )\end{matrix}$$

Unknown parameters in Expressions (2) and (3) are total five parameters; two parameters μ1 and μ2 and three component values x, y, and z of three-dimensional coordinates M⁽²⁰⁾. On the other hand, the number of equalities included in Expressions (2) and (3) is six, so that each of the unknown parameters, that is, three-dimensional coordinates (x, y, z) at the feature point Q20 can be calculated. Similarly, three-dimensional coordinates M^{(j)} at all of feature points Qj can be acquired.

In step S12, model fitting is performed. The “model fitting” is a process of generating an “individual model” in which input information of the face of a person to be authenticated is reflected by modifying a “standard model (of a face)” as a three-dimensional model of a prepared general (standard) face by using the information of the person to be authenticated. Concretely, a process of changing three-dimensional information of the standard model by using the calculated three-dimensional coordinates M^{(j)} and a process of changing two-dimensional information of the standard model by using the texture information are performed.

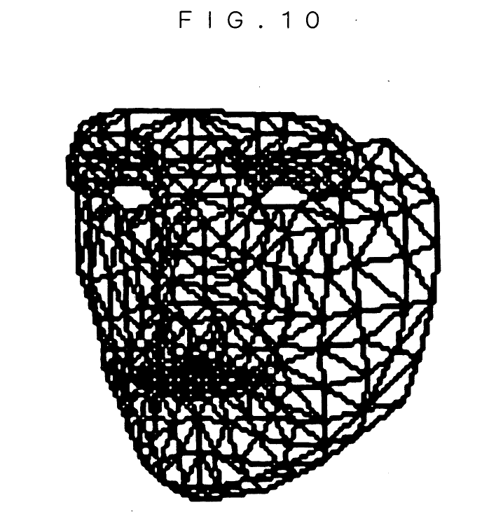

FIG. 10 shows a standard model of a three-dimensional face.

As shown in FIG. 10, the face standard model is constructed by apex data and polygon data and is stored as a three-dimensional model database 35 (FIG. 5) in the storage 3 or the like. The apex data is a collection of coordinates of an apex (hereinafter, also referred to as “standard control point”) COj of a feature part in the standard model and corresponds to the three-dimensional coordinates at each feature point Qj calculated in step SP11 in a one-to-one correspondence manner. The polygon data is obtained by dividing the surface of the standard model into small polygons (for example, triangles) and expressing the polygons as numerical value data. FIG. 10 shows the case where the apex of a polygon is constructed also by an intermediate point other than the standard control point COj. The coordinates at an intermediate point can be obtained by a proper interpolating method using coordinate values at the standard control points COj.

Model fitting for constructing an individual model from a standard model will now be described specifically.

First, the apex (standard control point COj) of each of feature parts of the standard model is moved to the feature point calculated in step SP11. Concretely, a three-dimensional coordinate value at each feature point Qj is substituted as the three-dimensional coordinate value of the corresponding standard control point COj, thereby obtaining a standard control point (hereinafter, also referred to as “individual control point”) Cj after the movement. In such a manner, the standard model can be modified to an individual model expressed by the three-dimensional coordinates M^{(j)}. The coordinates at an intermediate point other than the individual control point Cj in the individual model can be obtained by a proper interpolating method using the coordinate value of the individual control point Cj.

From the movement amount of each apex by the modification (movement), the scale, tilt, and position of the individual model in the case of using the standard model as a reference, which are used in step SP13 to be described later, can be obtained. Concretely, a position change of the individual model with respect to the standard model can be obtained by a deviation amount between a predetermined reference position in the standard model and a corresponding reference position in the individual model derived by the modification. According to a deviation amount between a reference vector connecting predetermined two points in the standard model and a reference vector connecting points corresponding to the predetermined two points in the individual model derived by the modification, a change in the tilt and a scale change in the individual model with respect to the standard model can be obtained. For example, by comparing coordinates at an intermediate point QM between the feature point Q1 at the inner corner of the right eye and the feature point Q2 at the inner corner of the left eye with coordinates at a point corresponding to the intermediate point QM in the standard model, the position of the individual model can be obtained. Further, by comparing the intermediate point QM with other feature points, the scale and the tilt of the individual model can be calculated.

The following expression (4) shows a conversion parameter (vector) vt expressing the correspondence relation between the standard model and the individual model. As shown in Expression (4), the conversion parameter (vector) vt is a vector having, as elements, a scale conversion index sz of both of the models, the conversion parameters (tx, ty, tz) indicative of translation displacements in orthogonal three axis directions, and conversion parameters (φ, θ, ψ) indicative of rotation displacements (tilt).
vt=(sz,φ,θ,ψ,tx,ty,tz)^{T} (4)
(where T denotes transposition, also below)

As described above, the process of changing the three-dimensional information of the standard model by using the three-dimensional coordinates M^{(j)} of the person to be authenticated is performed.

After that, the process of changing the two-dimensional information of the standard model by using the texture information is also performed. Concretely, the texture information of the parts in the input images G1 and G2 is assigned (mapped) to corresponding areas (polygons) on the three-dimensional individual model. Each area (polygon) to which the texture information is assigned on a three-dimensional model (such as individual model) is also referred to as a “patch”.

The model fitting process (step SP12) is performed as described above.

In step SP13, the individual model is corrected on the basis of the standard model as a reference. In the process, an alignment correction and a shading correction are made. The alignment correction is a correcting process for three-dimensional information, and the shading correction is a correcting process for two-dimensional information.

The alignment correction (face direction) correction is performed on the basis of the scale, tilt, and position of the individual model obtained in step SP12 using the standard model as a reference. More specifically, by converting coordinates of an individual control point in an individual model by using the conversion parameter vt (refer to Expression (4)) indicative of the relation between the standard model as a reference and the individual model, a three-dimensional face model having the same posture as that of the standard model can be created. That is, by the alignment correction, the three-dimensional information of the person to be authenticated can be properly normalized.

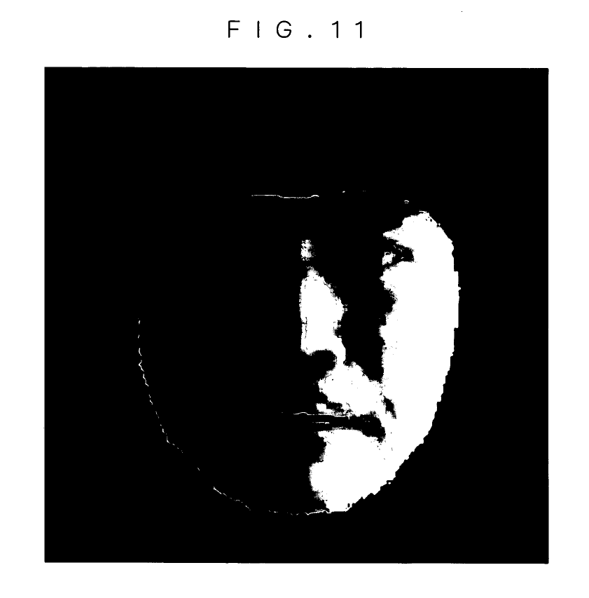

The shading correction is a process for correcting a brightness value (texture information (refer to FIG. 11)) of each of the pixels in a patch mapped to the individual model. By the shading correction, the difference in the texture information between the standard model and the individual model can be corrected, which occurs in the case where the positional relation between a light source and the subject at the time of capturing an image of a person of the standard model and that at the time of capturing an image of a person of the individual model are different from each other. That is, by the shading correction, the texture information as one of the two-dimensional information of the person to be authenticated can be normalized properly.

As described above, in the image normalizing process (step SP4), information of the person to be authenticated is generated in a normalized state as an individual model including both three-dimensional information and two-dimensional information of the person to be authenticated.

In step SP5 (FIG. 6), as information indicative of features of the individual model, three-dimensional shape information (three-dimensional information) and texture information (two-dimensional information) are extracted.

As the three-dimensional information, a three-dimensional coordinate vector of m pieces of the individual control points Cj in the individual model is extracted. Concretely, as shown in Expression (5), a vector h^{S} having, as elements, three-dimensional coordinates (Xj, Yj, Zj) of the m pieces of individual control points Cj (j=1, . . . , m) is extracted as the three-dimensional information (three-dimensional shape information).
h^{S}=(X1, . . . ,Xm,Y1, . . . ,Ym,Z1, . . . ,Zm)^{T} (5)

As the two-dimensional information, texture (brightness) information of a patch or a group (local area) of patches (hereinafter, also referred to as “local two-dimensional information”) near a feature part, that is, an individual control point in the face, which is important information for person authentication is extracted.

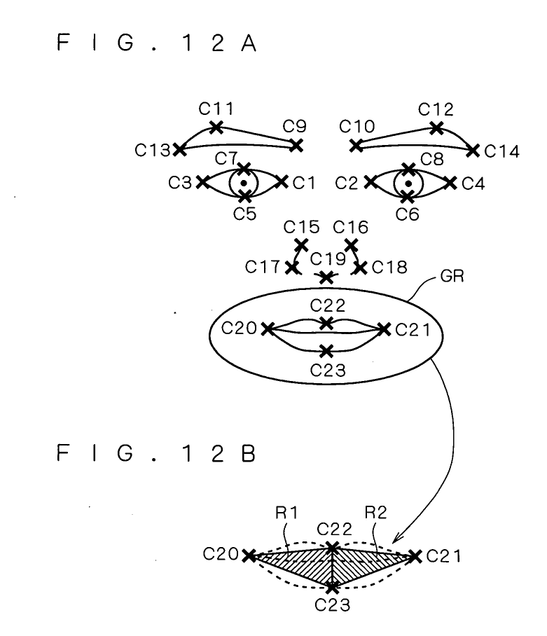

The local two-dimensional information is comprised of, for example, brightness information of pixels of local areas such as an area constructed by a group GR in FIG. 12 indicative of individual control points of a feature part after normalization (a patch R1 having, as apexes, individual control points C20, C22, and C23 and a patch R2 having, as apexes, individual control points C21, C22, and C23), an area constructed only by a single patch, or the like. The local two-dimensional information h^{(k)} (k=1, . . . , and L: the number of local areas) is expressed in a vector form as shown by Expression (6) when the number of pixels in the local area is n and brightness values of the pixels are BR1, . . . , and BRn. Information obtained by collecting the local two-dimensional information h^{(k)}in L local areas is also expressed as overall two-dimensional information.
h^{(k)}=(BR1, . . . ,BRn)^{T} (6)
(k=1 . . . L)

As described above, in step SP5, the three-dimensional shape information (three-dimensional information) and the texture information (two-dimensional information) are extracted as information indicative of a feature of the individual model.

The extracted information is used for authenticating operation (steps SP7 to SP9) which will be described later. The authenticating operation can be performed using the information obtained by Expression (6) as it is. In this case, however, when the number of pixels in the local area is large, the calculation amount in the authenticating operation is very large. In the preferred embodiment, therefore, to efficiently perform the authenticating operation by reducing the calculation amount, the information obtained by Expression (6) is compressed, and the authenticating operation is performed using the compressed information.

In step SP6, an information compressing process of converting the information extracted in step SP5 to information adapted to authentication is performed.

The information compressing process is performed in similar manners on the three-dimensional shape information h^{S} and each local two-dimensional information h^{(k)}. The case of performing the information compressing process on the local two-dimensional information h^{(k)}will be described in detail.

The local two-dimensional information h^{(k)}can be expressed in a basis decomposition form as shown by Expression (7) using average information (vector) hₐᵥₑ^{(k)} of the local area preliminarily acquired from a plurality of sample face images and a matrix P^{(k)} (which will be described below) expressed by a set of eigenvectors of the local area preliminarily calculated by performing KL expansion on the plurality of sample face images. As a result, local two-dimensional face information (vector) c^{(k)} is acquired as compression information of the local two-dimensional information h^{(k)}.
h^{(k)}=hₐᵥₑ^{(k)}+P^{(k)}c^{(k)} (7)

As described above, the matrix P^{(k)} in Expression (7) is calculated from a plurality of sample face images. Concretely, the matrix P^{(k)} is calculated as a set of some eigenvectors (basis vectors) having large eigenvalues among a plurality of eigenvectors obtained by performing the KL expansion on the plurality of sample face images. The basis vectors are stored in the basis vector database 26. When a face image is expressed by using, as basis vectors, eigenvectors showing greater characteristics of the face image, the features of the face image can be expressed efficiently.

For example, the case where local two-dimensional information h^{(GR)} of a local area constructed by a group GR shown in FIG. 12 is expressed in a basis decomposition form will be considered. When it is assumed that a set P of eigenvectors in the local area is expressed as P=(P1, P2, P3) by three eigenvectors P1, P2, and P3, the local two-dimensional information h^{(GR)} is expressed as Expression (8) using average information hₐᵥₑ^{(GR)} of the local area and three eigenvectors P1, P2, and P3. The average information hₐᵥₑ^{(GR)} is a vector obtained by averaging a plurality of pieces of local two-dimensional information (vectors) of various sample face images on a each corresponding factor. As the plurality of sample face images, it is sufficient to use a plurality of standard face images having proper variations.

$${h}^{( GR )} = {h}_{ave}^{( GR )} + ( P 1 P 2 P 3 ) ( \begin{matrix}c 1 \\ c 2 \\ c 3\end{matrix} ) \qquad ( 8 )$$

Expression (8) shows that the original local two-dimensional information can be reproduced by face information c^{(GR)}=(c1, c2, c3)^{T}. Specifically, it can be said that the face information c^{(GR)} is information obtained by compressing the local two-dimensional information h^{(GR)} of the local area constructed by the group GR.

Although the local two-dimensional face information c^{(GR)} acquired as described above can be used as it is for authenticating operation, in the preferred embodiment, the information is further compressed. Concretely, a process of converting a feature space expressed by the local two-dimensional face information c^{(GR)} to a subspace which increases the differences among persons is performed in addition. More specifically, a transformation matrix A is used which reduces the local two-dimensional face information c^{(GR)} of vector size “f” to the local two-dimensional feature amount d^{(GR)} of vector size “g” as shown by Expression (9). As a result, the feature space expressed by the local two-dimensional face information c^{(GR)} can be converted to a subspace expressed by the local two-dimensional feature amount d^{(GR)}. Thus, the differences among persons are made conspicuous.
d^{(GR)}=A^{T}c^{(GR)} (9)

The transformation matrix A is a matrix having the size of f×g. By selecting “g” pieces of main components having high ratio (F ratio) between within-class variance and between-class variance from the feature space by using multiple discriminant analysis (MDA), the transformation matrix A can be determined.

By executing processes similar to the information compressing process performed on the local two-dimensional information h^{(GR)} on all of the other local areas, local two-dimensional face feature amounts d^{(k)} of the local areas can be acquired. By applying a similar method also to the three-dimensional shape information h^{S}, a three-dimensional face feature amount d^{S} can be acquired.

A face feature amount “d” obtained by combining the three-dimensional face feature amount d^{S} with the local two-dimensional face feature amount d^{(k)} acquired in step SP6 can be expressed in a vector form by Expression (10).

$$d = ( \begin{matrix}{d}^{s} \\ {d}^{( 1 )} \\ ⋮ \\ {d}^{( L )}\end{matrix} ) \qquad ( 10 )$$

In the above-described processes in steps SP1 to SP6, the face feature amount “d” of a person to be authenticated is acquired from input face images of the person to be authenticated.

In steps SP7 to SP9, face authentication of a predetermined person is performed using the face feature amount “d”.

Concretely, overall similarity Re as similarity between a person to be authenticated (an object to be authenticated) and a person to be compared (an object to be compared) is calculated (step SP8). After that, a comparing operation between the person to be authenticated and the person to be compared on the basis of the overall similarity Re is performed (step SP9). The overall similarity Re is calculated using weight factors specifying weights on three-dimensional similarity Re^{S} and local two-dimensional similarity Re^{(k)} (hereinafter, also simply referred to as “weight factors”) in addition to the three-dimensional similarity Re^{S} calculated from the three-dimensional face feature amount d^{S} and local two-dimensional similarity Re^{(k)} calculated from the local two-dimensional face feature amount d^{(k)}. In step SP7, prior to steps SP8 and SP9, a process of determining the weight factors on the three-dimensional similarity Re^{S} and the local two-dimensional similarity Re^{(k)} is performed.

First, the process in step SP7 will be described.

The case of using a weight factor WT for three-dimensional information and a weight factor WS for two-dimensional information as weight factors on the three-dimensional similarity Re^{S} and local two-dimensional similarity Re^{(k)} will be described.

Expression (11) shows the relation between the weight factors WT and WS.
WT+WS=1
(where WT≧0, WS≧0) (11)

By the expression (11), when the value of the weight factor WT for three-dimensional information is increased, the value of the weight factor WS for two-dimensional information is set to be smaller. By setting the weight factors WT and WS to proper values according to environments and the like, more proper similarity can be calculated.

A method of determining a weight factor will be described in detail.

As a weight factor determining element (parameter), various variables obtained from subject conditions of a person to be authenticated, shooting conditions at the time of capturing images, or the like can be used.

For example, as a weight factor determining element (parameter), face distance information (parameter PT1), more specifically, distance α between the person to be authenticated and the camera can be used. The distance α is calculated on the basis of three-dimensional coordinates M^{(j)} calculated by the principle of triangulation in the three-dimensional reconstruction process (step SP11) and the position of the camera.

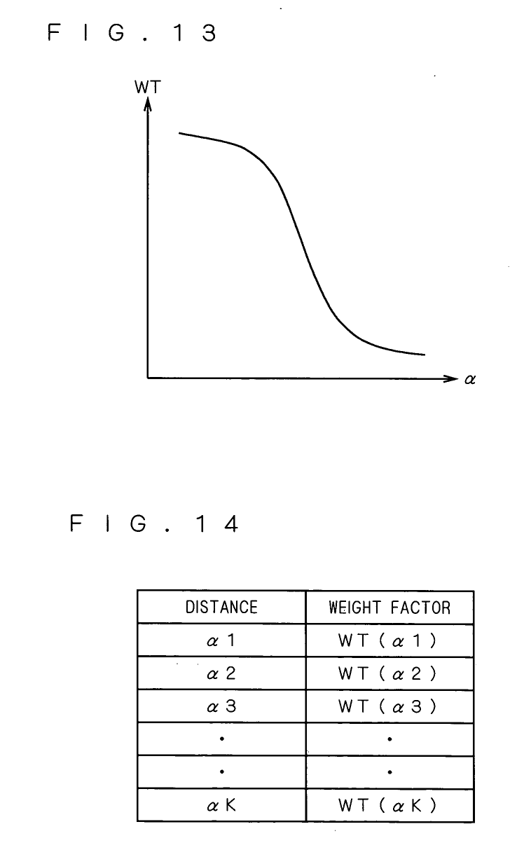

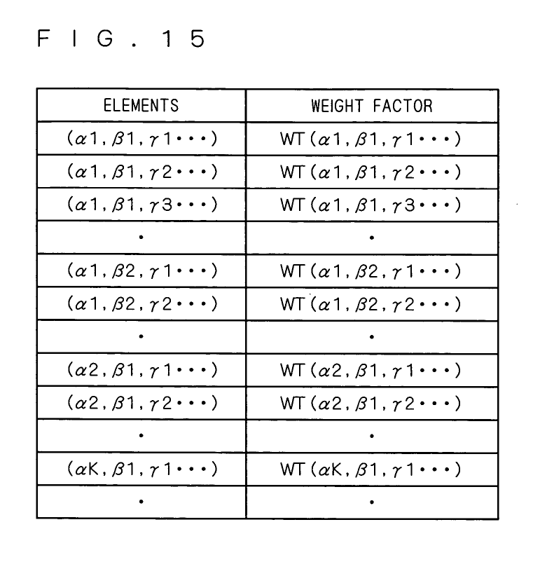

Although the reliability of two-dimensional information does not deteriorate so much by fluctuations in the distance α, the reliability of the three-dimensional shape information deteriorates relatively largely as the distance α increases. In the case where the distance α is large, the weight factor WT for the three-dimensional information can be decreased. The details will be described with reference to FIGS. 13 and 14.

FIG. 13 is a diagram showing the relation between the distance α between the person to be authenticated and the camera and the weight factor WT. FIG. 14 is a diagram showing correspondence between a predetermined distance αK and a weight factor WT (αK) determined on the basis of the relation of FIG. 13.

The value of the weight factor WT for three-dimensional information is expressed as shown in FIG. 13 using a function WT(α) of the distance α between the person to be authenticated and the camera. As shown in FIG. 14, a data table of the weight factors WT(αK) is stored as “weight information” in the weight factor determination information storage 27. Consequently, by calculating the distance α between the person to be authenticated and the camera at the time of determining a weight factor, the weight factor WT(α) for three-dimensional information can be determined using the data table. Further, when the weight factor WT for three-dimensional information is determined, the weight factor WS for two-dimensional information can be determined by Expression (11). The weight factor determined as described above is used for similarity calculation in step SP8.

As a weight factor determining element (parameter) other than the above, information of the direction of a face (a face direction information) at the time of image capturing (parameter PT2) can be also used. Concretely, in the case where a correction amount β of a rotation displacement in alignment correction in step SP13 is large, accuracy of assignment of texture information to an individual model deteriorates and the reliability of two-dimensional information decreases. Therefore, a process of increasing the weight factor WT for three-dimensional information is performed. As a concrete method, in a manner similar to the case of determining a weight factor from the distance α, a weight factor can be determined using weight information indicative of the relation between the correction amount β of the rotation displacement in alignment correction and the weight factor, stored in the weight factor determination information storing part 27.

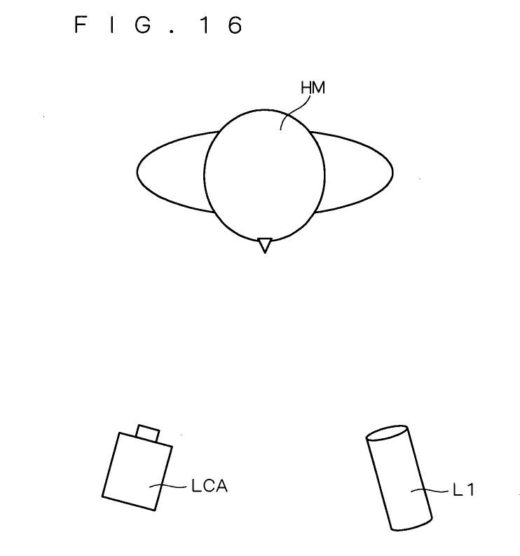

A weight factor can be also determined by using a plurality of weight factor determining elements. FIG. 15 is a diagram showing the relation between a plurality of determining elements (parameters) and weight factors. For example, as shown in FIG. 15, by expressing the weight factor WT for three-dimensional information as a function of a plurality of variables α, β, and γ including two variables of the parameters PT1 and PT2, a weight factor in which information of the parameters PT1 and PT2 and the like is reflected can be obtained.

In step SP8, evaluation is conducted on similarity between the face feature amount (feature amount to be compared) of a person to be compared which is preliminarily registered in the person parameter database 28 and the face feature amount of the person to be authenticated, calculated by steps SP1 to SP6. Concretely, similarity calculation is performed between the registered face feature amounts (feature amounts to be compared) (d^{SM} and d^{(k)M}) and the face feature amounts (d^{SI} and d^{(k)I}) of the person to be authenticated, thereby calculating three-dimensional similarity Re^{S} and local two-dimensional similarity Re^{(k)}. It is assumed that, in the preferred embodiment, the face feature amount of a person to be compared in the face authenticating operation is acquired prior to the operation of FIG. 6. Concretely, by performing processes similar to steps SP1 to SP6 on a single person to be compared or each of a plurality of persons to be compared, the face feature amount “d” of each person to be compared is preliminarily acquired as the face feature amount peculiar to the person and is pre-stored (registered) in the person parameter database 28.

The three-dimensional similarity Re^{S} between the person to be authenticated and the person to be compared is acquired by calculating Euclidean distance Re^{S} between corresponding vectors as shown by Expression (12).
Re^{S}=(d^{SI}−d^{SM})^{T}(d^{SI}−d^{SM}) (12)

The local two-dimensional similarity Re^{(k)} is acquired by calculating Euclidean distance Re^{(k)} of each of vector components of the feature amounts in the corresponding local areas as shown by Expression (13).
Re^{(k)}=(d^{(k)I}−d^{(k)M})^{T}(d^{(k)I}−d^{(k)M}) (13)

As shown in Expression (14), the three-dimensional similarity Re^{S} and the local two-dimensional similarity Re^{(k)} are combined by using the weight factors determined in step SP7 and the overall similarity Re as similarity between the person to be authenticated (object to be authenticated) and the person to be compared (object to be compared) can be acquired.

$$Re = WT \cdot {Re}^{s} + WS \cdot {\sum }_{k} {Re}^{( k )} \qquad ( 14 )$$

In step SP9, authentication determination is performed on the basis of the overall similarity Re. The authentication determination varies between the case of face verification and the case of face identification as follows.

In the face verification, it is sufficient to determine whether an input face (the face of a person to be authenticated) is that of a specific registered person or not. Consequently, by comparing the similarity Re between the face feature amount of the specific registered person, that is, a person to be compared (a feature amount to be compared) and the face feature amount of the person to be authenticated with a predetermined threshold, whether the person to be authenticated is the same as the person to be compared or not is determined. Specifically, when the similarity Re is smaller than a predetermined threshold TH1, it is determined that the person to be authenticated is the same as the person to be compared.

On the other hand, the face identification is to determine the person of an input face (the face of the person to be authenticated). In the face identification, all of similarities between face feature amounts of persons registered and the feature amount of the face of a person to be authenticated are calculated, and identity between the person to be authenticated and each of the persons to be compared is determined. A person to be compared having the highest identity among the plurality of persons to be compared is determined as the same person as the person to be authenticated. Specifically, a person to be compared who corresponds to the minimum similarity Reₘᵢₙ among the similarities between the person to be authenticated and each of the plurality of persons to be compared is determined as the same person as the person to be authenticated.

By separately calculating the similarity in three dimensions obtained from the three-dimensional shape information and the similarity in two dimensions obtained from the two-dimensional information and using both of the similarities for authentication determination as described above, higher-accuracy authentication can be realized. Since the similarity in three dimensions and the similarity in two dimensions used for authentication can be adjusted by weight factors determined from subject conditions of the person to be authenticated or the like, preferable authentication which is not easily influenced by the subject conditions and the like can be performed.

Modifications

Although the preferred embodiment of the present invention has been described above, the present invention is not limited to the above description.

For example, although the face distance information (parameter PT1) or the face direction information (parameter PT2) at the time of image capture is used as a determination element (parameter) used for determining a weight factor in the foregoing preferred embodiment, the present invention is not limited to the information. Concretely, the following parameters PT3 to PT5 can be used.

PT3 (reliability of feature point extraction executed in step SP3):

Since the reliability of feature point extraction exerts an influence on accuracy of a three-dimensional face model created in step SP4, in the case where reliability of feature point extraction is low, the weight factor WT for three-dimensional information is decreased. The reliability of feature point extraction can be evaluated on the basis of similarity between a template and an extracted part in the template matching at the time of feature part extraction.

PT4 (lighting condition information at the time of image capturing):

When an average brightness value of an input two-dimensional image is largely different from registered data, it is determined that a change between lighting at the time of registration and lighting at the time of input is large, and the weight factor WS for two-dimensional information is decreased. When the ratio between lightness of the background in a two-dimensional image and that of the face area is low, the weight factor WS for two-dimensional information is decreased.

PT5 (information of time elapsed from registration):

When time elapsed from registration of the feature amount to be compared is long, the possibility of occurrence of an appearance change by make-up, beard, or the like is high, so that the weight factor WS for two-dimensional information is decreased.

The face distance information (parameter PT1) at the time of image capturing and the face direction information (parameter PT2) at the time of image capturing can be also expressed as “subject conditions of an object to be authenticated”. The lighting condition information (parameter PT4) at the time of image capturing can be also expressed as “image capturing condition at the time of image capturing”.

Although the brightness value of each of pixels in a patch is used as two-dimensional information in the foregoing preferred embodiment, color tone of each patch may be used as the two-dimensional information.

Although the similarity calculation is executed using the face feature amount “d” obtained by a single image capturing operation in the foregoing preferred embodiment, the present invention is not limited to the calculation. Concretely, by performing the image capturing operation twice on the person to be authenticated and calculating similarity between face feature amounts obtained by the image capturing operations of twice, whether the values of the face feature amounts thus acquired are proper or not can be determined. In the case where the values of the face feature amounts thus acquired are improper, image capturing can be performed again.

Although the MDA is used as a method of determining the transformation matrix A in step SP6 in the foregoing preferred embodiment, the present invention is not limited to the method. For example, the Eigenspace method (EM) for acquiring the projective space to increase the difference between the within-class variance and the between-class variance from a predetermined feature space may be used.

Although three-dimensional shape information of a face is acquired by using a plurality of images which are input from a plurality of cameras in the preferred embodiment, the present invention is not limited to the method. Concretely, three-dimensional shape information of the face of a person to be authenticated may be acquired by using a three-dimensional shape measuring device constructed by a laser beam emitter L1 and a camera LCA as shown in FIG. 16 and measuring reflection light of a laser beam emitted from the laser beam emitter L1 by the camera LCA. However, by a method of acquiring three-dimensional shape information with an input device including two cameras as in the foregoing preferred embodiment, as compared with an input device using a laser beam, three-dimensional shape information can be acquired with a relatively simpler configuration.

Although the case of using texture (brightness) information as the two-dimensional information has been described in the foregoing preferred embodiment, the present invention is not limited to the case. For example, as the two-dimensional information, information of a position in a plane in an image (such as feature point relative position information) may be used together with or in place of the texture information.

While the invention has been shown and described in detail, the foregoing description is in all aspects illustrative and not restrictive. It is therefore understood that numerous modifications and variations can be devised without departing from the scope of the invention.

What is claimed is:

1. An authentication apparatus comprising:
a first acquiring part for acquiring three-dimensional information of a first object to be authenticated;
a second acquiring part for acquiring two-dimensional information of said first object; and
an authenticating part for performing an authenticating operation on said first object by using said three-dimensional information and said two-dimensional information.

2. The authentication apparatus according to claim 1, wherein
said authenticating part performs authentication while adjusting weights between said three-dimensional information and said two-dimensional information.

3. The authentication apparatus according to claim 2, wherein
said authenticating part includes:
a first calculator for calculating a first similarity between said three-dimensional information of said first object and pre-registered three-dimensional information of a second object to be compared;
a second calculator for calculating a second similarity between said two-dimensional information of said first object and two-dimensional information of said second object;
an adjuster for adjusting weight factors specifying weights between said first similarity and said second similarity;
a third calculator for calculating overall similarity between said first object and said second object by combining said first similarity with said second similarity using said weight factors; and
a determining part for performing authentication determination on the basis of said overall similarity.

4. The authentication apparatus according to claim 3, wherein
said adjuster determines said weight factors on the basis of image shooting conditions used at the time of image capturing.

5. The authentication apparatus according to claim 3, wherein
said adjuster determines said weight factors on the basis of subject conditions of said first object at the time of image capturing.

6. The authentication apparatus according to claim 3, wherein
said adjuster determines said weight factors on the basis of time elapsed from a time point when information of said second object is registered.

7. The authentication apparatus according to claim 1, wherein
said three-dimensional information is obtained on the basis of a plurality of images of said first object, which are captured from different positions, and
said two-dimensional information is obtained on the basis of at least one of said plurality of images.

8. The authentication apparatus according to claim 1, wherein
said authenticating part generates an individual model by modifying a prepared three-dimensional model by using said three-dimensional information and said two-dimensional information, normalizes the individual model, and performs an authenticating operation on said first object with the individual model.

9. The authentication apparatus according to claim 1, wherein
said authenticating part performs an authenticating operation on said first object by using a three-dimensional coordinate vector, which is obtained on the basis of said three-dimensional information, of individual control points on said first object and texture information, which is obtained on the basis of said two-dimensional information, of at least one patch near an individual control point on said first object.

10. The authentication apparatus according to claim 9, wherein
said first object is the face of a person, and
said authenticating part obtains a three-dimensional face feature amount by compressing information of a collection of three-dimensional coordinate vectors of said individual control points, obtains a local two-dimensional face feature amount by compressing said texture information, obtains a face feature amount by combining said three-dimensional face feature amount with said local two-dimensional face feature amount, and performs an authenticating operation on said first object with said face feature amount.

11. The authentication apparatus according to claim 9, wherein
said first object is the face of a person, and
said individual control points include a point of at least one of parts of an eye, an eyebrow, a nose, and a mouth.

12. An authentication method comprising:
a) a step of acquiring three-dimensional information of a first object to be authenticated;
b) a step of acquiring two-dimensional information of said first object; and
c) a step of performing an authenticating operation on said first object by using said three-dimensional information and said two-dimensional information.

13. The authentication method according to claim 12, wherein
said authenticating operation is performed while adjusting weights between said three-dimensional information and said two-dimensional information.

14. The authentication method according to claim 13, wherein
said step c) includes:
c-1) a step of calculating a first similarity between said three-dimensional information of said first object and pre-registered three-dimensional information of a second object to be compared;
c-2) a step of calculating a second similarity between said two-dimensional information of said first object and two-dimensional information of said second object;
c-3) a step of adjusting weight factors specifying weights between said first similarity and said second similarity;
c-4) a step of calculating overall similarity between said first object and said second object by combining said first similarity with said second similarity using said weight factors; and
c-5) a step of performing authentication determination on the basis of said overall similarity.

15. The authentication method according to claim 14, wherein
in said step c-3), said weight factors are determined on the basis of shooting conditions used at the time of image capturing.

16. The authentication method according to claim 14, wherein
in said step c-3), said weight factors are determined on the basis of subject conditions of said first object at the time of image capturing.

17. The authentication method according to claim 14, wherein
in said step c-3), said weight factors are determined on the basis of time elapsed from a time point when information of said second object is registered.

18. The authentication method according to claim 12, wherein
said three-dimensional information is obtained on the basis of a plurality of images of said first object, which are captured from different positions, and
said two-dimensional information is obtained on the basis of at least one of said plurality of images.

19. The authentication method according to claim 12, wherein
said step c) includes a step of generating an individual model by modifying a prepared three-dimensional model by using said three-dimensional information and said two-dimensional information, normalizing the individual model, and performing an authenticating operation on said first object with the individual model.

20. The authentication method according to claim 12, wherein
said step c) includes a step of performing an authenticating operation on said first object by using a three-dimensional coordinate vector, which is obtained on the basis of said three-dimensional information, of individual control points on said first object and texture information, which is obtained on the basis of said two-dimensional information, of at least one patch near an individual control point on said first object.

21. The authentication method according to claim 20, wherein
said first object is the face of a person, and
said step c) includes a step of obtaining a three-dimensional face feature amount by compressing information of a collection of three-dimensional coordinate vectors of said individual control points, obtaining a local two-dimensional face feature amount by compressing said texture information, obtaining a face feature amount by combining said three-dimensional face feature amount with said local two-dimensional face feature amount, and performing an authenticating operation on said first object with said face feature amount.

22. The authentication method according to claim 20, wherein
said first object is the face of a person, and
said individual control points include a point of at least one of parts of an eye, an eyebrow, a nose, and a mouth.
